(19) United States
(12) Patent Application Publication
(10) Pub. No.: US 2001/0019011 A1
(43) Pub. Date: Sep. 6, 2001

(54) Apparatus for transporting streams of tobacco particles and the like

(76) Inventors: Clemens Schmick, Geesthacht (DE); Franz-Peter Koch, Schwarzenbek (DE)

Correspondence Address: VENABLE, Post Office Box 34385, Washington, DC, 20043-9998, US

(21) Appl. No.: 09/785,508

(22) Filed: Feb. 20, 2001

(30) Foreign Application Priority Data
Feb. 18, 2000 (DE) 100 07 479.0

(51) Int. Cl. B65G 15/04; B65G 23/04; A24C 5/18

(52) U.S. Cl. 198/832; 198/716; 198/836.1; 131/84.1; 131/84.3; 131/110

(57) ABSTRACT

An elongated channel for the assembly of successive increments of a continuous tobacco stream and for lengthwise transport of the tobacco stream in a cigarette making machine is composed of a foraminous belt having a lower reach overlying the channel and located beneath a suction chamber, and of two additional belts having recessed surfaces which flank the channel. Those tobacco particles which enter the recesses in the surfaces of the additional belts form part of densified sections of rod-like fillers of discrete cigarettes and the recesses further serve to receive the teeth of one or more driven pulleys which are employed to move the additional belts lengthwise.

### BACKGROUND OF THE INVENTION

The invention relates to improvements in apparatus for transporting streams of particulate material, such as smokable fibrous materials. More particularly, the invention relates to improvements in apparatus for converting flows or showers of loose fibrous material into rod-like accumulations of such materials, e.g., into rod-like bodies which are ready for conversion into fillers of cigarette rods or the like.

It is known to feed a shower of comminuted tobacco leaf laminae into a channel one side of which is bounded by one side of a foraminous belt conveyor; the other side of such belt conveyor is adjacent a suction chamber which causes the conveyor to attract tobacco particles and to thus convert the shower into a stream or flow which is ready to be trimmed (i.e., relieved of surplus tobacco) prior to entering a wrapping station where the trimmed stream is draped into a continuous running web of cigarette paper or the like. Reference may be had, for example, to British patent No. 919 150 wherein one side of a tobacco receiving channel is defined by a driven foraminous belt which attracts and entrains the particles of the inflowing shower. Two additional sides of the channel are bounded by stationary walls. Thus, the flow of particles which are directed into the channel is attracted to a moving wall (foraminous belt) and is caused to move along two stationary walls. Such mode of conveying tobacco particles in a cigarette making machine has found widespread acceptance in many branches of the tobacco processing industry. Reference may also be had to published German patent application Serial No. 42 15 059; this publication describes and shows a tobacco channel the top side of which is formed by the lower reach of an endless foraminous belt conveyor; the lower reach is disposed beneath a suction chamber so that streamlets of air flowing upwardly into the channel entrain the particles of a shower of comminuted tobacco leaves and cause the lower reach to accumulate at its underside a growing stream of tobacco particles ready to be converted into a rod-like filler. The conversion involves removal of surplus tobacco and advancement of the thus trimmed stream into a wrapping mechanism wherein the trimmed rod-like stream is draped into a web of cigarette paper or the like.

### OBJECTS OF THE INVENTION

An object of the present invention is to provide a novel and improved apparatus for transporting tobacco particles or other particulate material along a composite path wherein a flow of loose particles is converted first into a relatively dense stream prior to conversion of such stream into a rod-like filler of a cigarette rod or the like.

Another object of the invention is to provide a novel and improved conveying apparatus wherein the conversion of a shower or another flow of relatively loose particles into a relatively dense stream or rod or filler of such particles can be carried out with a heretofore unachievable degree of reliability and reproducibility.

A further object of the instant invention is to provide a novel and improved apparatus for making cigarettes with dense ends.

An additional object of this invention is to provide a novel and improved combination of endless flexible conveying devices for flows of comminuted tobacco leaves and the like.

Still another object of the invention is to provide a novel and improved method of manipulating accumulations of fibrous materials by combined mechanical and pneumatic fluid-operated means.

A further object of the invention is to provide a novel and improved cigarette making machine which embodies the above outlined apparatus.

Another object of the invention is to provide a cigarette making machine wherein the fragmentized smokable material is gathered, conveyed, equalized and further processed in a novel and improved way.

An additional object of the invention is to provide an apparatus which can receive smokable material from a distributor and which can process the thus received material in a novel and improved way.

Still another object of the invention is to provide novel and improved belt or band conveyor means for use in connection with the transporting of fibrous smokers' products during the making of plain or filter cigarettes, cigarillos, cigars and the like.

A further object of the invention is to provide novel and improved devices for the transport of endless flexible belts in cigarette making and analogous tobacco processing machines.

### SUMMARY OF THE INVENTION

The invention is embodied in an apparatus which can be utilized for the transport of particulate material, e.g., smokable material such as shreds of tobacco leaf laminae. The improved apparatus comprises a channel having elongated walls defining a stream receiving and guiding passage or path. At least one of the walls is movable lengthwise and has a stream-contacting surface provided with material-receiving recesses, and the apparatus further comprises means for moving the at least one wall.

The at least one wall preferably forms part of an endless flexible element, such as a toothed belt, band or chain. The toothed belt is provided with alternating teeth and tooth spaces and the tooth spaces constitute or can constitute the aforementined recesses. The means for moving the at least one wall can include a pulley which is rotatable about a predetermined axis and includes a cage having bars parallel with the axis of the pulley and mating with the teeth of the belt. The moving means can further include a second pulley having a tootless (such as smooth) peripheral surface, and the belt can be trained over such smooth-surfaced pulley. The means for driving the pulley or pulleys can include a suitable prime mover, e.g., a digital servo drive.

The channel can be constructed and assembled in such a way that two of its walls are movable lengthwise; however, it often suffices if only one of the at least two walls has a recessed stream-contacting surface. It is within the purview of the invention to provide one or two walls of the channel with recessed (toothed) stream-contacting surfaces.

The channel can further comprise a film of a current-conducting material which coats at least one or each stream-contacting surface.

The width of the path for particulate material can be selected in such a way that it decreases in the direction of forward movement of the stream; this can entail a gradual narrowing and attendant densification of the stream.

The at least one wall of the channel can consist, at least in part, of a plastic material, such as a polyurethane elastomer, polyethylene, polypropylene or a polyester elastomer.

If the stream is to be converted into rod-like fillers of smokers' products each of which has a predetermined length, the recesses in the stream-contacting surface of surfaces of one or more walls can be spaced apart from each other lengthwise of the at least one wall or lengthwise of each recessed wall by a whole multiple (including one) of the predetermined length.

In accordance with a presently preferred embodiment, the walls of the channel include a first wall bounding the path from above, a second wall adjacent one side of the path, and a third wall adjacent another side of the path. The recessed side is or can be provided on at least one of the second and third walls. The first wall is or can be foraminous, and the apparatus can further include a housing for the channel; such housing preferably includes one or more portions supporting at least one of the second and third walls, or each of the second and third walls, from below.

The recesses are or can be equidistant from each other, as seen in the direction of lengthwise movement of the wall or walls.

The means for showering particulate material (e.g., upwardly) into a predetermined portion of the path forms no part of the present invention. For example, such showering means can be constructed, assembled and operated in a manner as disclosed in commonly owned U.S. Pat. No. 5,072,742 granted Dec. 17, 1991 to Heitmann for “METHOD OF AND APPARATUS FOR MAKING A FILLER OF SMOKABLE MATERIAL”.

The novel features which are considered as characteristic of the invention are set for in particular in the appended claims. The improved apparatus itself, however, both as to its construction and the modes of assembling and utilizing the same, together with numerous additional important and advantageous features and attributes thereof, will be best understood upon perusal of the following detailed description of certain presently preferred specific embodiments with reference to the accompanying drawings.

### BRIEF DESCRIPTION OF THE DRAWINGS

FIG. 1 is a fragmentary transverse vertical sectional view of a particle transporting apparatus which can be installed in a cigarette making machine and is constructed and assembled and operates in accordance with one presently preferred embodiment of the invention;

FIG. 2 is an enlarged fragmentary perspective view of a detail in the apparatus embodying the structure of FIG. 1;

FIG. 3 is a fragmentary partly elevational and partly sectional view of a belt-driving pulley or wheel which can be utilized in the apparatus of FIGS. 1 and 2; and

FIG. 4 is a fragmentary elevational view of a further detail in the apparatus embodying the structure of FIGS. 1 and 2.

### DESCRIPTION OF PREFERRED EMBODIMENTS

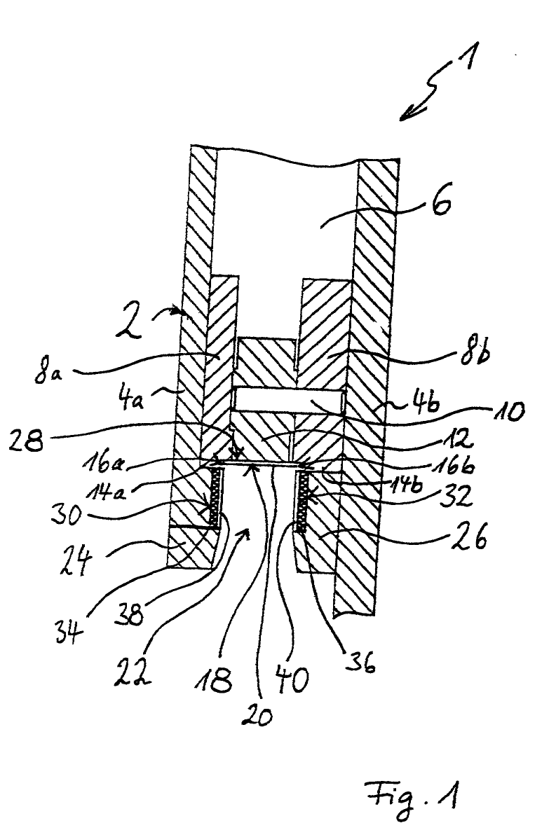

FIG. 1 illustrates a portion of an apparatus 1 which can be utilized in a cigarette rod making machine, and more specifically in that portion of such machine wherein an ascending shower of particulate material (such as fragments of tobacco leaves, comminuted sheets of reconstituted tobacco and/or comminuted artificial tobacco) is converted into a stream or flow. The leader of the stream is continuously converted into a rod-like filler which is draped into a web of cigarette paper or other suitable wrapping material to form therewith a continuous moving cigarette rod. The leader of the moving cigarette rod is repeatedly severed during advancemement through a so-called cutoff to yield a file or row of plain cigarettes of unit length or multiple unit length ready to be admitted into a magazine or directly into a packing machine. Reference may be had, for example, to commonly owned U.S. Pat. No. 4,729,386 granted Mar. 8, 1988 to Heitmann for “APPARATUS FOR MAKING CIGARETTES WITH DENSE ENDS” or to commonly owned U.S. Pat. No. 4,805,641 granted Feb. 21, 1989 to Radzio et al. for “METHOD AND APPARATUS FOR ASCERTAINING THE DENSITY OF WRAPPED TOBACCO FILLERS AND THE LIKE”.

The channel in the housing 2 of the apparatus 1 shown in FIG. 1 defines a horizontal passage or path 22 which can receive an ascending shower of tobacco particles from a distributor of the type disclosed, for example, in the aforementioned U.S. Pat. No. 5,072,742. The shower which rises into and in the path 22 is attracted to the underside of the lower reach or stretch 20 of an endless foraminous belt or band or wall 18 which is advanced at right angles to the plane of FIG. 1 and moves the growing tobacco stream into the range of a trimming or equalizing device (see, for example, the trimming device 19 shown in FIG. 1 of the aforementioned U.S. Pat. No. 4,805,641). The apparatus (rod forming unit) 1 of the present invention constitutes an improvement of that part of a cigarette rod making or analogous machine which is designed to initiate and control the flow of the ascending particulate fibrous material on its way toward and with the foraminous belt or wall 18 toward the trimming or equalizing station.

The housing 2 of the apparatus 1 comprises two parallel stationary panels 4a, 4b having lower portions which indirectly flank the channel defining the path 22, and upper portions which flank a suction chamber 6 serving to cause tobacco particles to ascend into the channel and to advance with the lower reach 20 of the foraminous belt or wall 18 in a direction at right angles to the plane of FIG. 1. The outlet (not shown) of the suction chamber 6 is connected to the intake of a suitable suction generating device (not shown), e.g., to a suction pump, a blower or the like. The chamber 6 extends downwardly to the upper side 28 of the lower reach 20 of the belt or wall 18 of the aforementioned channel.

The inner sides of the panels 4a, 4b are partially overlapped by discrete strip-shaped members or inserts 8a, 8b. The insert 8b carries a horizontal shaft 10 for a roller 12 serving as a smooth-surfaced pulley for the belt or wall 18. The insert 8b further carries a shaft for at least one additional roller or pulley (not shown) which also guides or guides and advances the illustrated lower reach 20 of the belt or wall 18.

The lower marginal portions 14a, 14b of the inserts 8a, 8b are respectively provided with narrow confronting surfaces 16a, 16b which serve as guide means for the respective edge faces of the lower reach 20 of the endless belt or wall 18. This lower reach bounds the path 22 from above and the underside of the path is open in order to enable the shower of tobacco particles to rise toward and to be intercepted by the underside of the lower reach 20. In accordance with a feature of the present invention, the sides of the path 22 are also bounded by mobile parts, namely by parallel or substantially parallel stretches or reaches of endless recessed belts or bands or walls 34, 36 respectively advancing in tracks 30, 32 provided in the confronting vertical inner sides of two cheeks 24, 26 carried by or forming part of the panels 4a and 4b of the housing 2. In FIG. 1, the cheek 24 is affixed to the lower part of the panel 4a of the housing 2, and the cheek 26 is affixed to the lower part of the strip-shaped member or insert 8b.

The inner sides of the cheeks 24, 26 taper upwardly and inwardly to guide the ascending particles of fibrous material (such as shreds of tobacco leaf. laminae) toward the deepmost (uppermost) portion of the path 22, i.e., toward and against the underside of the lower reach or stretch 20 of the endless foraminous belt or wall 18.

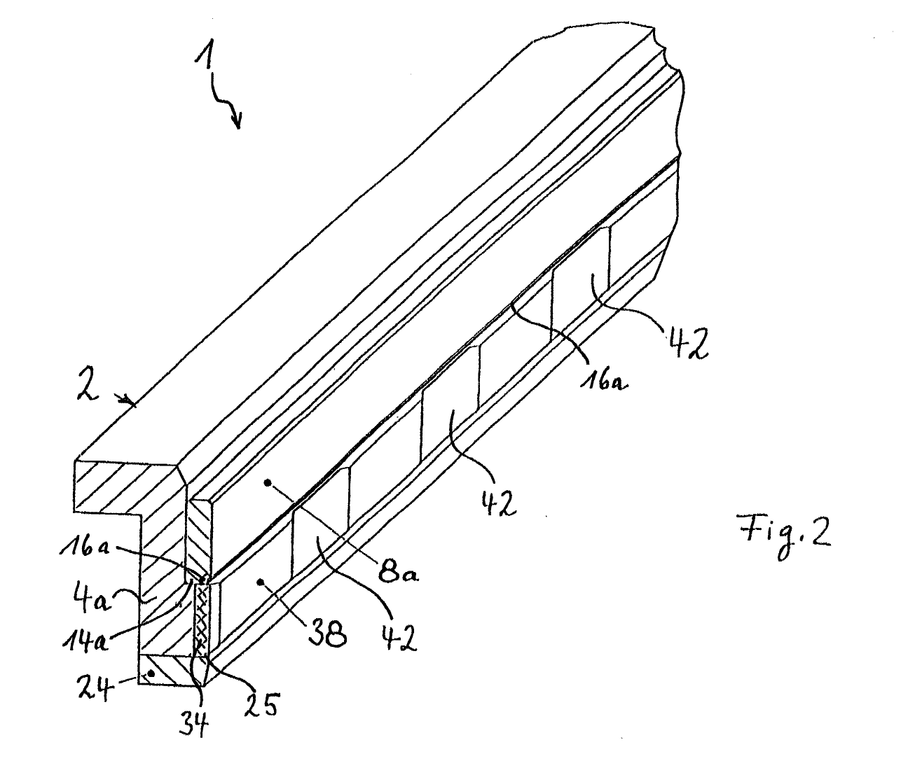

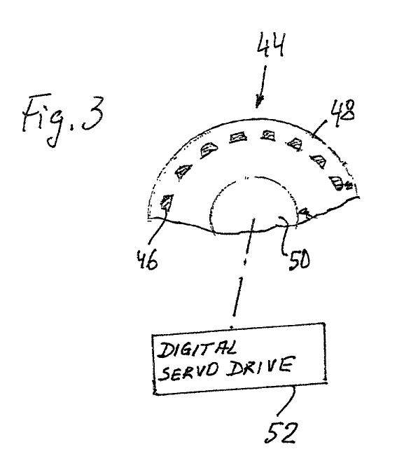

The illustrated reaches or stretches of the belts or walls 34, 36 are respectively reinforced by tooth-like portions 38, 40 which cooperate with pulleys or gears 44 (one shown in FIG. 3) to advance the belts or walls 34, 36 relative to the cheeks 24, 26 and in the same direction and at the same speed as the lower reach 20 of the endless foraminous belt or wall 18. The tooth-like portions or reinforcements 38, 40 (hereinafter also called teeth) alternate with recesses or tooth spaces 42 (see particularly FIG. 2) for the axially parallel rod-shaped teeth 46 extending between two axially spaced-apart discs 48 (one shown in FIG. 3) of the gears 44. The discs 48 are mounted on a driver shaft 50 receiving torque from a prime mover of the rod making machine including the apparatus 1 shown in FIGS. 1 to 4. It will be seen that the growing tobacco stream in the path 22 is or can be advanced from three sides, namely from above by the foraminous belt or wall 18 and from two sides by the recessed belts or walls 34 and 36 of the improved channel. As already mentioned hereinbefore, the underside of the path 22 must remain open for entry of the rising shower of tobacco particles. The teeth or bars 46 of the pulley 44 shown in FIG. 3 are parallel with the axis of the shaft 50.

The pulley 44 of FIG. 3 resembles the rotary cylinder in a squirrel cage.

FIG. 2 is an enlarged and partly simplified perspective view of a portion of the apparatus 1 shown in FIG. 1. The strip-shaped member or insert 8a, the upper part of which guides one edge face of the lower reach 20 of the belt or wall 18, is located at a level above the upper edge of the belt or wall 34. The cheek 24 at the underside of the member or insert 8a guides the belt or wall 34 from below, and the outer side of the belt or wall 34 lies against the adjacent upright side of the panel 4a. The right-hand half of the structure shown in FIG. 1 can be a mirror image of the structure shown in FIG. 2. FIG. 2 further shows the teeth or reinforcing portions 38 as well as the recesses or spaces 42 which alternate with the teeth 38 and serve to at least mechanically entrain the fragments of smokable material while such material is being advanced from above by the lower reach 20 of the belt or wall 18. All of spaces or recesses 42 can have identical sizes and shapes, and the same applies for the reinforcing portions 38.

The recesses 42 preferably serve several important purposes, such as cooperating with the drive means for the belts or walls 34, 36 as well as to ensure that the respective portions of the fully grown tobacco stream in the path 22 contain more tobacco than the portions between pairs of confronting reinforcements 38, 40. This can be utilized to make cigarettes or other rod-shaped articles having fillers which include portions containing greater and portions containing lesser quantities of tobacco particles. It is often advisable to produce cigarettes having tobacco fillers with dense ends, namely both ends of a plain cigarette or at least that end of a filter cigarette which is lighted by the smoker, i.e., which is remote from the filter mouthpiece. A machine which is designed to make rod-shaped smokers' products containing rod-shaped fillers having dense ends is disclosed, for example, in commonly owned U.S. Pat. No. 4,703,764 granted Nov. 3, 1987 to Marquardt et al. for “METHOD AND APPARATUS FOR MAKING ROD-LIKE FILLERS FROM SEVERAL TYPES OF FIBROUS MATERIAL”.

FIG. 2 further shows a projection 25 which is provided on the cheek 24 and serves to hold the toothed belt or wall 34 in the recess 30. A similar projection is or can be provided on the cheek 26 to support the lower edge face of the belt or wall 36 from below, i.e., to hold this wall in the track 32.

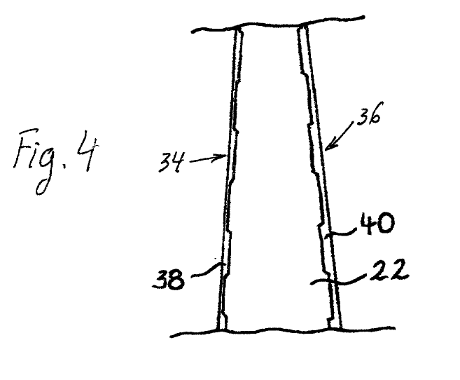

Each of the belts or walls 34, 36 can be trained over one or more toothed pulleys or rollers 44 of the type shown in FIG. 3 as well as over one or more pulleys or rollers having smooth cylindrical peripheral surfaces. Each such smooth-surfaced pulley or roller can include a cylindrical peripheral surface disposed between two circular disc-shaped flanges. The driving (toothed) pulleys or wheels 44 can receive rotary motion from a suitable prime mover, e.g., from a digital servo drive schematically shown at 52 in FIG. 4 and known as Type DVP5-2-4-T00 (distributed by the Firm Arnold Müller GmbH & Co. KG, D-7323 Kirchheim/Teck, Federal Republic Germany). Such drives are also known as AMK drives and are utilized extensively in machines for the making of smokers' products, especially in modern high-speed machines such as those known as PROTOS 1-8, PROTOS 2 and PROTOS 2-2. These machines are used for the making of cigarettes and are distributed by the assignee of the present application.

An advantage of the feature that selected portions of a continuous tobacco stream are densified during the making of such stream is that the densified portions are less likely to expand than if the densification is carried out upon completed conversion of a shower into a stream, e.g., in the region of the trimming or equalizing station. Reference may be had, for example, to published German patent application Serial No. 11 09 071 which discloses a trimming or equalizing device designed to remove more tobacco from selected portions of an advancing tobacco stream and to remove less tobacco from those portions which are to constitute densified parts of the filler in a finished cigarette. It is desirable to begin with the establishment of densified or densifiable portions of a continuous tobacco stream as far away from the trimming and wrapping stations as possible. Thus, the gathering of large quantities of tobacco particles in spaced-apart portions of the stream well ahead of the trimming station for the tobacco stream (such trimming station receives successive increments of the stream at a location which follows the channel including the bands or walls 18, 34, 36) constitutes an advantageous feature of the improved apparatus.

Another important advantage of the belts or walls 34, 36 of the improved channel is that the densification of selected portions of the stream gathering in the path 22 persists for a relatively long period of time because the recessed walls 34, 36 advance with the stream in the path 22. In other words, and in contrast to the operation of the combined trimming and densifying means in the machine disclosed in the aforementioned published German patent application Serial No. 11 09 071, the recesses 42 and the reinforced portions 38, 40 of the belts or walls 34, 36 do not move relative to but rather with the stream which is formed in the path 22.

The utilization of one or more pulleys of the type shown in FIG. 3 as a means for advancing at least one of the belts or walls 34, 36 also constitutes a desirable feature of the improved apparatus. Such cage-like rotary pulleys with discrete parallel bars or teeth 46 (preferably having a trapeziform cross-sectional outline) are much less likely to gather and squash particles of tobacco, i.e., such pulleys are less likely to initiate a contamination of the belts or walls 34, 36 and of other parts of the apparatus 1. The likelihood of rapid contamination of the belts or walls 34, 36 and/or of the bars 46 and/or of the foraminous belt or wall 18 can be further reduced by coating the bars 46 with a suitable repellant which opposes adherence of crushed tobacco particles to parts of the apparatus.

The pulley 44 exhibits the additional advantage that it can cooperate with one or more similar pulleys or with one or more simpler (smooth-surfaced) pulleys to properly and reliably stretch the reaches of the belt or wall 34 and/or 36 to a desired extent.

The likelihood of contamination of the apparatus 1 can be reduced still further by utilizing an endless flexible belt or wall which is devoid of pronounced teeth or is devoid of any teeth. If such belt or wall is driven by a pulley having a cylindrical peripheral surface (such as the pulley 12), the belt or wall is likely to slip relative to the pulley; such apparatus can be equipped with means for monitoring the desired locations of densified portions and for utilizing the thus obtained signals to regulate the slip between the smooth-surfaced pulley or pulleys and the toothless belt or wall. For example, the monitoring can involve ascertaining those portions of a wrapped stream (i.e., of a finished cigarette rod) which are being severed by the customary cutoff serving to repeatedly sever the leader of the moving cigarette rod to form a file of cigarettes of unit length or multiple unit length.

An advantage of training at least one of the belts or walls 34, 36 over an idler pulley which is devoid of teeth is that this, too, reduces the likelihood of contamination of the apparatus with crushed tobacco particles. Thus, a toothless pulley is less likely to crush tobacco particles than a toothed pulley or gear.

The belts or walls 18, 34, 36 of the improved channel can be dimensioned to guide and advance the tobacco stream in the path 22 all the way from the tobacco showering location to the inlet into the wrapping mechanism. Referring, for example, to FIG. 3 of the aforementioned U.S. Pat. No. 5,072,742, this would mean that the walls or belts 34, 36 of the improved apparatus would extend from the pulley 71 to the pulley 72, i.e., the same as the foraminous conveyor 61 (corresponding to the foraminous belt 18 in the apparatus of the present invention). Such dimensioning of the belts or walls 34, 36 further contributes to superior densification of selected portions of a tobacco stream in the path 22 because the recessed surfaces of the belts or walls 34, 36 remain in uninterrupted contact with the tobacco stream for the maximum possible period of time.

The aforementioned digital servo drive 52 for the driven pulley or pulleys which transmits or transmit motion to the belt or wall 34 and/or 36 is that such drive permits for highly accurate selection of the RPM, i.e., for highly accurate synchronizing of the locations of densified portions of the stream with the locus where the cigarette rod is severed by the trimming device. In other words, the digital servo drive 52 or an equivalent thereof can render it more likely that the densified portions of fillers in the cigarettes are located at the ends, i.e., in the regions where the particles of tobacco are likely to escape and contaminate the interior of a cigarette pack, a pocket or a handbag.

It is further within the purview of the invention to provide recesses 42 only in one of the belts or walls 34, 36, to maintain the non-recessed rail or wall at a standstill and actually drive the other (recessed) wall at the speed of the lower reach 20 of the belt or wall 18.

Still further, it is often advisable to provide the recessed surface or surfaces of the belt or wall 34 and/or 36 with a coat or film of an electrically conductive material. This enhances the antistatic characteristics of the thus coated wall, i.e., the wall is not likely to accumulate dangerous charges in the cigarette rod making machine. By employing a film of electrically conductive material, one can ensure that the surface resistance of the wall or belt 34 and/or 36 is maintained below 3×10⁸ Ω, preferably below 3×10⁶ Ω. Thus, such belts or walls meet the provisions of DIN (German Industrial Norm) 22104 pertaining to antistatic conveyor belts.

The belts or walls 34, 36 can be made of any one of a wide variety of suitable materials. Certain presently preferred materials include polyolefins, particularly polyethylene and polypropylene or hytrol, especially polyester elastomers.

The overall length of the belts or walls 34, 36 is or can be a whole multiple of the length of cigarettes or other ultimate products and is preferably divisible by the pitch of such walls or belts. Such relationsip ensures that the densified portion(s) of the filler is or are located at one or both ends of the finished product (such as a cigarette of unit length). In other words, such selection of the length of the belts 34, 36 also contributes to accurate positioning of densified portions of fillers in the ultimate products.

As can be seen in FIG. 4, the orientations of confronting reaches or stretches of the belts or walls 34, 36 can be selected in such a way that the width of the path 22 narrows gradually and continuously in the direction of forward movement of the tobacco stream. This, too, contributes to predictable densification of selected portions of the stream beginning well ahead of the trimming or equalizing station. Such station is shown at 88 in FIG. 3 of U.S. Pat. No. 5,072,742. The just described orientation of confronting stretches of the belts or walls 34, 36 is in contrast to prior proposals which suggest a mounting of stationary sidewalls in a manner to provide a tobacco-confining channel of constant width as seen in the direction of forward movement of the tobacco stream toward the trimming and wrapping stations. Therefore, those successive increments of the tobacco stream which reach the trimming and wrapping stations of a conventional machine must undergo a rather pronounced and abrupt reduction of their cross-sectional areas. Such reduction is normally effected by resorting to a conventional finger or horn which initiates the draping of a continuous cigarette paper web around successive increments of the trimmed stream arriving at the wrapping station. The finger or horn exerts a pronounced stress upon the advancing stream and can even adversely affect the operation of the entire machine. All this can be reliably avoided by providing the cigarette making machine with the improved apparatus which effects a gradual condensation and gradual localized densification of the tobacco stream. The aforementioned finger or horn abruptly engages and effects a pronounced compression of successive minute or small portions of the advancing tobacco stream; on the other hand, the endless flexible belt or belts 34, 36 subjects or subject the stream to a gradual compressive or densifying action because it or they remain in relatively long-lasting and large-area contact with the advancing tobacco stream. For example, the path 22 can have a length of up to 1000 mm and a width which can decrease gradually and very slightly, e.g., by 2 mm between the two ends of the path 22.

The just discussed gradual and long-lasting engagement and entrainment of the tobacco stream in the path 22 defined by the channel including the belts or walls 18, 34, 36 subjects the tobacco stream to additional beneficial treatments as concerns the composition, uniformity and density of the stream advancing toward the trimming device. Avoidance of abrupt densification of the tobacco stream at the inlet to the wrapping station (due to the elimination of the need for the aforediscussed finger or horn) constitutes a highly important, desirable and unobvious improvement which is attributable to the provision of one or more belts or walls 34, 36 which remain in relatively long-lasting contact with the tobacco stream.

Still further, it is often desirable to make the belts or walls 34, 36 of an air-permeable material. This renders it possible to employ suction chambers (e.g., chambers analogous to or constituting suitably configurated extensions of the suction chamber 6) which are outwardly adjacent the tobacco-containing stretches or reaches of the belts or walls 34, 36 and can attract tobacco particles into and maintain the thus attracted particles in the recesses 42 advancing along the path 22. It has been found that such undertaking even more reliably ensures predictable densification of selected portions of the tobacco stream in the path 22.

In accordance with a further feature of the present invention, at least one of the belts or walls 34, 36 can be provided with recesses having different depths. For example, deeper recesses can alternate with shallower recesses. Such design is often desirable and advantageous if the plain cigarettes furnished by a cigarette making machine embodying the apparatus of the present invention are to be fed into a filter cigarette making machine (known as tipping machine), e.g., into a machine described and illustrated in commonly owned U.S. Pat. No. 5,135,008 granted Aug. 4, 1992 to Oesterling et al. for “METHOD OF AND APPARATUS FOR MAKING FILTER CIGARETTES”. It is often desirable to construct the tobacco-containing portion of a filter cigarette in such away that it includes a slightly densified end which is adjacent the filter mouthpiece and a denser end which is remote from the filter mouthpiece, i.e., which is lighted by the smoker.

Without further analysis, the foregoing will so fully reveal the gist of the present invention that others can, by applying current knowledge, readily adapt it for various applications without omitting features that, from the standpoint of prior art, fairly constitute essential caracteristics of the generic and specific aspects of the above outlined contribution to the art of conveying flows of particulate material and, therefore, such adaptations should and are intended to be comprehended within the meaning and range of equivalence of the appended claims.

What is claimed is:

1. Apparatus for transporting a stream of particulate material, comprising;
a channel having elongated walls defining a stream-receiving and guiding path, at least one of said walls being movable lengthwise and having a stream-contacting surface provided with material-receiving recesses; and
means for moving said at least one wall.

2. The apparatus of claim 1, wherein the particulate material is a smokable material.

3. The apparatus of claim 1, wherein said at least one wall forms part of an endless flexible element.

4. The apparatus of claim 3, wherein said endless flexible element includes a toothed belt.

5. The apparatus of claim 4, wherein said toothed belt has alternating teeth and tooth spaces, said tooth spaces constituting said recesses.

6. The apparatus of claim 4, wherein said means for moving includes a pulley rotatable about a predetermined axis and including a cage having bars parallel with said axis and mating with the teeth of said belt.

7. The apparatus of claim 6, further comprising a second pulley having a toothless peripheral surface, said belt being trained over said second pulley.

8. The apparatus of claim 1, wherein said means for moving includes a rotary pulley and a digital servo drive for said pulley.

9. The apparatus of claim 1, wherein at least two of said walls are movable lengthwise.

10. The apparatus of claim 9, wherein only one of said at least two walls has a recessed stream-contacting surface.

11. The apparatus of claim 9, wherein each of said at least two walls has a recessed stream-contacting surface.

12. The apparatus of claim 1, wherein said channel further comprises a film of current-conducting material coating said stream-contacting surface.

13. The apparatus of claim 1, wherein said path has a width which decreases in the direction of lengthwise movement of said at least one wall.

14. The apparatus of claim 1, wherein said at least one wall consists at least in part of a material selected from the group consisting of polyurethane elastomers, polyethylene, polypropylene and polyester elastomers.

15. The apparatus of claim 1, wherein said stream is convertible into rod-like fillers of smokers' products each having a predetermined length and said material-receiving recesses are spaced apart from each other lengthwise of said at least one wall by a whole multiple of said predetermined length.

16. The apparatus of claim 1, wherein said walls include a first wall bounding said path from above, a second wall adjacent one side of said path and a third wall adjacent another side of said path, said surface being provided on at least one of said second and third walls.

17. The apparatus of claim 16, wherein said first wall is foraminous.

18. The apparatus of claim 16, further comprising a housing for said channel, said housing having portions supporting said second and third walls from below.

19. The apparatus of claim 1, wherein said recesses are equidistant from each other as seen in the direction of lengthwise movement of said at least one wall.

20. The apparatus of claim 1, further comprising means for showering particulate material into a predetermined portion of said path.
